(19) United States
(12) Patent Application Publication
(10) Pub. No.: US 2019/0391357 A1
(43) Pub. Date: Dec. 26, 2019

(54) CAMERA FILTER FRAME AND CAMERA FILTER UNIT

(71) Applicant: KABUSHIKI KAISHA TSUSO, Nagano (JP)

(72) Inventor: Hideo KOBAYASHI, Nagano (JP)

(21) Appl. No.: 16/491,138

(22) PCT Filed: Feb. 16, 2018
(86) PCT No.: PCT/JP2018/005382

§ 371 Date: Sep. 4, 2019

(30) Foreign Application Priority Data
Mar. 8, 2017 (JP) 2017-043517

(51) Int. Cl. G02B 7/00; G03B 11/00

(52) U.S. Cl. CPC G02B 7/006; G03B 11/00

(57) ABSTRACT

This filter frame (10) for a camera has: a front-side ring (4) for holding a first polarization filter (2) on the inner peripheral side thereof; a rear-side ring (5) disposed concentrically and behind the front-side ring (4), and capable of rotatably holding the front-side ring (4); and a rotation angle range-regulating mechanism (58) for regulating the angular range for the relative rotation of the front-side ring (4) and the rear-side ring (5). The rotation angle range-regulating mechanism (58) is provided with: a protruding portion (16) provided on the rear-facing annular surface (33) of the front-side ring (4); and a circular arc groove (17) which is provided in the front-facing annular surface (56) of the rear-side ring (5), and into which the protruding portion (16) is inserted. When the protruding portion (16) is positioned at an end of the circular arc groove (17), the relative rotational angle position of the front-side ring (4) and the rear-side ring (5) can be regulated.

### FIELD

The present invention relates to a camera filter frame in which a front ring for holding an optical element is held to a rear ring in a rotatable manner. The present invention also relates to a camera filter unit in which the camera filter frame holds an optical element such as a polarization filter.

### BACKGROUND

A camera filter unit in which a camera filter frame holds a polarization filter is disclosed in Patent Literature 1. In this patent literature, the camera filter frame includes a front ring for holding the polarization filter on the inner peripheral side, and a rear ring for holding the front ring in a rotatable manner. When photographing is performed using the camera filter unit, the rear ring is attached to the front end of a lens-barrel of a camera, and the front ring is rotated relative to the rear ring. Photographing is then performed by maintaining the front ring at a rotation angular position that can exert desired photographic effects.

### CITATION LIST

### Patent Literature

Patent Literature 1: Japanese Patent Application Laid-open No. 2004-264555

### SUMMARY

### Technical Problem

The desired photographic effects can be easily and certainly exerted by correctly regulating the rotation angular position of the front ring with respect to the rear ring. However, a camera filter frame that is capable of regulating relative rotation angular positions of the front ring and the rear ring has not been proposed.

In view of the foregoing, an object of the present invention is to provide a camera filter frame that is capable of regulating relative rotation angular positions of a front ring and a rear ring. Another object of the present invention is to provide a camera filter unit in which the camera filter frame holds an optical element.

### Solution to Problem

To achieve the above-described object, a camera filter frame according to the present invention includes a front ring having a holding portion for holding an optical element on the inner peripheral side, a rear ring disposed coaxially with the front ring to hold the front ring in a rotatable manner from a back side, and a rotation angular range regulating mechanism for regulating an angular range in which the front ring and the rear ring rotate relative to each other. The rotation angular range regulating mechanism includes a protruding part that is provided for one of the front ring and the rear ring, and a circular arc groove into which the protruding part is inserted that is provided for the other ring.

The camera filter frame according to the present invention includes the rotation angular range regulating mechanism, which is formed of the protrusion and the circular arc groove into which the protrusion is inserted. Accordingly, the front ring rotates relative to the rear ring within a rotation angular range in which the protrusion moves from one end to the other end of the circular arc groove. In this manner, a rotation angular position of the front ring with respect to the rear ring can be regulated between two positions that are a rotation angular position in which the protrusion is positioned at one end of the circular arc groove and a rotation angular position in which the protrusion is positioned at the other end of the circular arc groove.

According to the present invention, it is desirable that the front ring includes a rearward annular surface facing the rear side, and the rear ring includes a forward annular surface facing the front side and slidably contacting the rearward annular surface. Further, it is desirable that the protruding part is provided for one of the rearward annular surface and the forward annular surface, and the circular arc groove is provided for the other surface. By causing the forward annular surface provided for the rear ring and the rearward annular surface provided for the front ring to oppose each other in the fore-and-aft direction and slidably contact each other, the front ring and the rear ring rotate without rattling. In addition, by providing the protrusion for one of the forward annular surface and the rearward annular surface opposing each other in the fore-and-aft direction and slidably contacting each other, and providing the annular groove for the other surface, even when the rotation angular range regulating mechanism is provided, the camera filter frame can be prevented or inhibited from becoming longer in an axial direction. Furthermore, by providing the protrusion for one of the forward annular surface and the rearward annular surface opposing in the fore-and-aft direction, and providing the annular groove for the other surface, the camera filter frame can be prevented from becoming larger in size in a radial direction as compared to a case in which a pair of annular surfaces opposing each other in the radial direction are provided between a front ring and a rear ring, and a protrusion is provided for one of the pair of annular surfaces, while an annular groove is provided for the other surface.

According to the present invention, it is desirable that a first mark is provided at an angular position about the axis in which the protruding part is formed on an outer peripheral surface of one ring out of the front ring and the rear ring for which the protruding part is provided, and a second mark is provided at an angular position about the axis corresponding to one end in a circumferential direction of the circular arc groove on an outer peripheral surface of the other ring. In this manner, the first mark and the second mark form a line in the fore-and-aft direction when the protrusion reaches one end of the annular groove. Accordingly, it can be visually confirmed that the rear ring and the front ring are at predetermined relative rotation angular positions.

According to the present invention, the rotation angular range regulating mechanism can regulate a rotation angular range in which the front ring and the rear ring rotate relative to each other to a rotation angular range smaller than 90°. In this manner, when a polarization filter or cross filter is held as an optical element, the relative angular positions of the front ring and the rear ring are easily maintained while exerting desired photographic effects.

According to the present invention, it is desirable that the front ring includes an annular wall portion extending in the radial direction, an annular plate portion extending from the inner peripheral end of the annular wall portion to the outer peripheral side toward the rear side, an annular projection portion projecting for a shorter distance than the annular wall portion from the rear end of the annular plate portion toward the outer peripheral side, and an annular recess that is partitioned by the annular wall portion, the annular plate portion, and the annular projection portion. Further, it is desirable that the rear ring includes an insertion portion that is inserted into the annular recess from the outer peripheral side. In this manner, a simple structure enables the rear ring to hold the front ring in a rotatable manner. In addition, in this manner, the front ring can be held to the rear ring in a rotatable manner without interposing another member between the front ring and the rear ring.

According to the present invention, the front ring includes a front annular wall portion extending in the radial direction in a front and the outer peripheral side of the annular plate portion, and an intermediate annular plate portion extending from the inner peripheral end of the front annular wall portion to the rear side along an axis. The front annular wall portion includes the rearward annular surface. The annular plate portion extends in the radial direction from the rear end of the intermediate annular plate portion toward the inner peripheral side, and the rear ring includes a rear ring annular portion extending along the axis, and a rear ring front annular plate portion extending from an outer peripheral end of a front surface of the rear ring annular portion to the front side. A front surface portion closer to the inner peripheral side than the rear ring front annular plate portion among the front surface of the rear ring annular portion is the forward annular surface, and the insertion portion can be a portion that projects from the rear ring annular portion to the inner peripheral side. In this manner, it is easy to allow the front ring to include the rearward annular surface, and the rear ring to include the forward annular surface slidably contacting the rearward annular surface, and the insertion portion.

According to the present invention, the rear ring can have a second holding portion for holding a second optical element on the inner peripheral side. In this manner, the front ring and the rear ring both can hold the optical element.

Next, a camera filter unit according to the present invention includes the above-described camera filter frame, and the optical element held to the holding portion of the front ring.

According to the present invention, in the camera filter frame, the rotation angular position of the front ring with respect to the rear ring can be regulated between two positions that are a first rotation angular position in which the protrusion of the rotation angular range regulating mechanism is positioned at one end of the circular arc groove, and a second rotation angular position in which the protrusion is positioned at the other end of the circular arc groove. In this manner, since the rotation angular position about the axis of the optical element held to the front ring can be regulated in the camera filter unit, the desired photographic effects corresponding to the rotation angular position can be easily and certainly exerted.

In addition, a camera filter unit according to another embodiment of the present invention includes the above-described camera filter frame, the optical element held to the holding portion of the front ring, and the second optical element held to the second holding portion of the rear ring.

According to the present invention, in the camera filter frame, the rotation angular position of the front ring with respect to the rear ring can be regulated between the two positions, which are the first rotation angular position in which the protrusion of the rotation angular range regulating mechanism is positioned at one end of the circular arc groove, and the second rotation angular position in which the protrusion is positioned at the other end of the circular arc groove. In this manner, since the relative rotation angular positions about the axis of the optical element held to the front ring and the second optical element held to the rear ring can be regulated in the camera filter unit, the desired photographic effects corresponding to the relative rotation angular positions of the two optical elements can be easily and certainly exerted.

Furthermore, a camera filter unit according to another embodiment of the present invention includes the optical element held to the holding portion of the above-described front ring, and the second optical element held to the second holding portion of the rear ring. Further, the optical element and the second optical element are both polarization filters, and first light quantity passing through the optical element and the second optical element when the protruding part is positioned at one end in the circumferential direction of the circular arc groove is larger than second light quantity passing through the optical element and the second optical element when the protruding part is positioned at the other end in the circumferential direction of the circular arc groove.

According to the present invention, in the camera filter frame, the rotation angular position of the front ring with respect to the rear ring can be regulated between the two positions, which are the first rotation angular position in which the protrusion of the rotation angular range regulating mechanism is positioned at one end of the circular arc groove, and the second rotation angular position in which the protrusion is positioned at the other end of the circular arc groove. Accordingly, with the camera filter unit according to the present invention in which the front ring and the rear ring both hold the polarization filters, the first light quantity of light passing through the two sheets of polarization filters when the camera filter frame is disposed at the first rotation angular position, and the second light quantity of light passing through the two sheets of polarization filters when the camera filter frame is disposed at the second rotation angular position can be correctly regulated. Thus, photographing aiming for accurate focusing and the desired photographic effects can be quickly performed by focusing the camera at the first rotation angular position that can exert the bright first light quantity, and then clicking the shutter while disposing the camera filter frame at the second rotation angular position.

### BRIEF DESCRIPTION OF DRAWINGS

FIG. 1 is a perspective view of a camera filter unit to which the present invention is applied.

FIG. 2 is a perspective view of the camera filter unit to which the present invention is applied.

FIG. 3 is a longitudinal sectional view of the camera filter unit in FIG. 1.

FIG. 4 is a partially enlarged sectional view of the camera filter unit in FIG. 1.

FIG. 5 includes a rear view of a front ring and a front view of a rear ring.

FIG. 6 is a diagram for describing an assembly method of a camera filter unit.

### DESCRIPTION OF EMBODIMENTS

The following describes a camera filter unit to which the present invention is applied with reference to the drawings.

(Overall Structure)

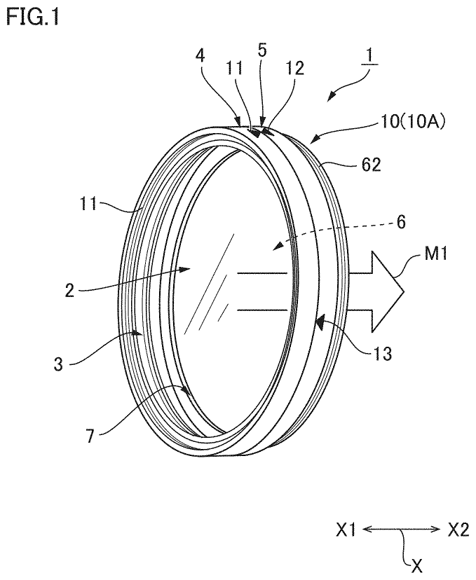

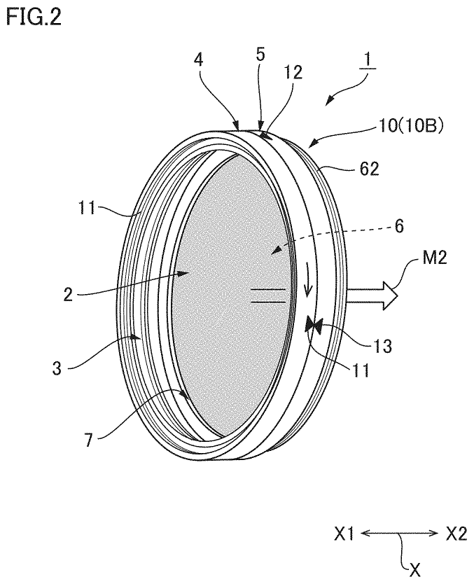

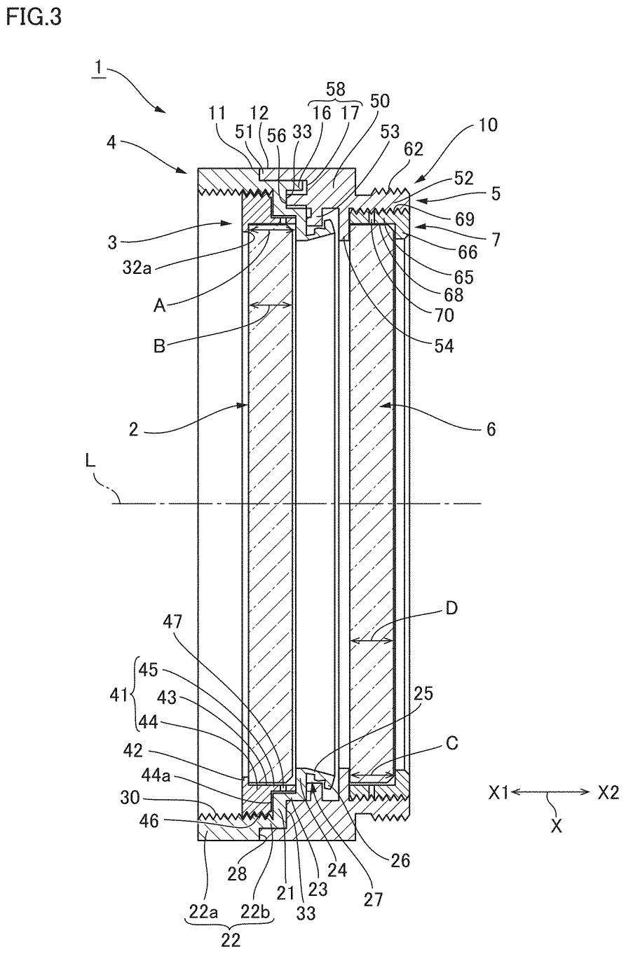

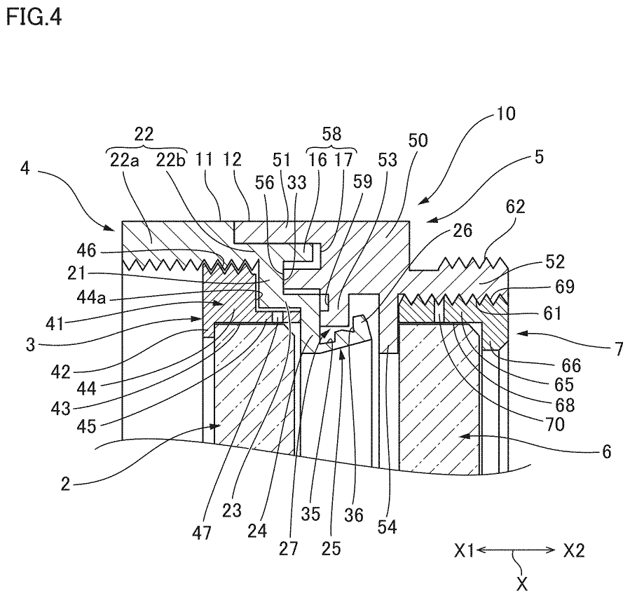

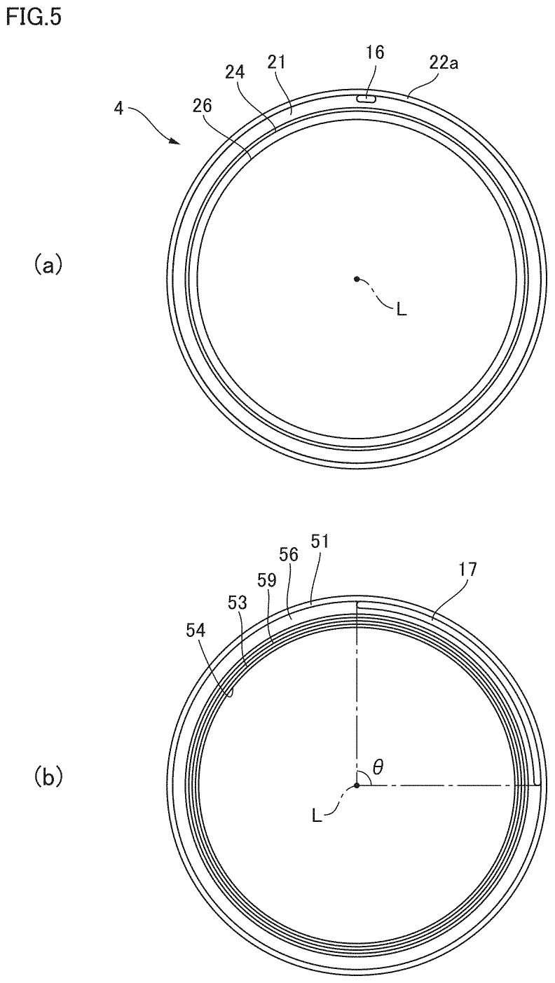

FIG. 1 and FIG. 2 are perspective views of a camera filter unit to which the present invention is applied. In FIG. 1, a camera filter frame is disposed at a first rotation angular position, and in FIG. 2, the camera filter frame is disposed at a second rotation angular position. FIG. 3 is a longitudinal sectional view of the camera filter unit in FIG. 1. FIG. 4 is a partially enlarged sectional view of the camera filter unit in FIG. 1. FIG. 5A is a rear view of a front ring, and FIG. 5B is a front view of a rear ring. In each of the figures, in order to make the structure of the camera filter unit easy to understand, scales are partially changed for schematic illustration.

As illustrated in FIG. 1, a camera filter unit 1 according to the present embodiment includes a disc-like first polarization filter 2 (optical element), a front inner ring 3 for holding the first polarization filter 2 coaxially, a front ring 4 for holding the front inner ring 3 coaxially from the outer peripheral side, and a rear ring 5 for holding the front ring 4 coaxially. In addition, the camera filter unit 1 includes a disc-like second polarization filter 6 (second optical element), and a rear inner ring 7 for holding the second polarization filter 6 coaxially. The rear inner ring 7 is held to the inner peripheral side of the rear ring 5. The front inner ring 3, the front ring 4, the rear ring 5, and the rear inner ring 7 are made of metal. In the present embodiment, these are made of aluminum. In the following description, the direction of the camera filter unit 1 along an axis L is assumed to be a fore-and-aft direction X. In the fore-and-aft direction X, the side on which the front ring 4 is positioned is assumed to be a front X1 (front side), and the side on which the rear ring 5 is positioned is a rear X2 (rear side).

The front ring 4 holds the first polarization filter 2 via the front inner ring 3. The rear ring 5 holds the second polarization filter 6 via the rear inner ring 7. In addition, the rear ring 5 holds the front ring 4 in a rotatable manner about the axis L. The front inner ring 3, the front ring 4, the rear ring 5, and the rear inner ring constitute a camera filter frame 10. In the present embodiment, the first polarization filter 2 and the second polarization filter 6 are both circular polarization filters.

In the front ring 4, a front mark 11 (first mark) is provided at one position in the circumferential direction on the outer peripheral surface facing the outer side in the radial direction orthogonal to the axis L. In the rear ring 5, a first rear mark 12 (second mark) and a second rear mark 13 (second mark) are provided at two separate positions in the circumferential direction on the outer peripheral surface facing the outer side in the radial direction orthogonal to the axis L. The first rear mark 12 and the second rear mark 13 are provided within an angular range smaller than 90° about the axis L.

In addition, as illustrated in FIG. 3, the camera filter unit 1 includes a rotation angular range regulating mechanism 58 for regulating an angular range in which the front ring 4 and the rear ring 5 rotate relative to each other. The rotation angular range regulating mechanism 58 includes a protruding part 16 that protrudes from the front ring 4 to the rear X2 in the direction along the axis L, and a circular arc groove 17 that receives the protruding part 16 from the front X1 in the rear ring 5.

An angular range that is regulated by the rotation angular range regulating mechanism 58 corresponds to an angular range between the first rear mark 12 and the second rear mark 13 provided for the rear ring 5. In other words, the camera filter frame 10 can change the relative angles of the front ring 4 and the rear ring 5 between a first rotation angular position 10A in which the front mark 11 and the first rear mark 12 match each other in the circumferential direction as illustrated in FIG. 1, and a second rotation angular position 10B in which the front mark 11 and the second rear mark 13 match each other in the circumferential direction as illustrated in FIG. 2.

First light quantity M1 (see FIG. 1) of light passing through the first polarization filter 2 held to the front ring 4 and the second polarization filter 6 held to the rear ring 5 at the first rotation angular position 10A is larger as compared to second light quantity M2 (see FIG. 2) of light passing through the first polarization filter 2 and the second polarization filter 6 at the second rotation angular position 10B. In the present embodiment, the first light quantity M1 of light passing through the first polarization filter 2 and the second polarization filter 6 when the camera filter frame 10 is at the first rotation angular position 10A is larger than light quantity of light passing through the first polarization filter 2 and the second polarization filter 6 when the camera filter frame 10 is at other rotation angular positions. The first light quantity M1 is the maximum light quantity that can be obtained by observing light passing through the first polarization filter 2 and the second polarization filter 6 disposed coaxially, while rotating these filters relative to each other.

(Front Ring)

As illustrated in FIG. 3, the front ring 4 includes a front annular wall portion 21 extending in the radial direction orthogonal to the axis L, a front annular plate portion 22 extending from the outer peripheral end of the front annular wall portion 21 to the front along the axis L, an intermediate annular plate portion 23 extending from the inner peripheral end of the front annular wall portion 21 to the rear X2 along the axis L, a rear annular wall portion 24 extending from the rear end of the intermediate annular plate portion 23 toward the inner peripheral side in the radial direction, a rear annular plate portion 25 extending from the inner peripheral end of the rear annular wall portion 24 to the rear X2, and an annular protrusion (annular projection portion) projecting for a shorter distance than the rear annular wall portion 24 from the rear end of the rear annular plate portion 25 toward the outer peripheral side. On the outer peripheral surface of the front ring 4, an annular recess 27 is formed by the rear annular wall portion 24, the rear annular plate portion 25, and the annular protrusion 26.

The front annular plate portion 22 includes a thick portion 22a and a thin portion 22b in this order from the front X1 toward the rear X2. The thick portion 22a projects to the outer peripheral side more than the thin portion 22b does. An annular step 28 is formed by the thick portion 22a and the thin portion 22b on the outer peripheral surface of the front annular plate portion 22. An internal thread 30 is formed on the inner peripheral surface of the front annular plate portion 22.

The front annular wall portion 21 includes an annular rearward annular surface 33 orthogonal to the axis L. The protruding part 16 is provided at one position in the circumferential direction of the rearward annular surface 33. As illustrated in FIG. 4 and FIG. 5, the protruding part 16 is provided at a portion on the outer peripheral side of the rearward annular surface 33, and it projects to the rear X2 in the axis L direction. The intermediate annular plate portion 23 has a constant thickness dimension in the radial direction. The rear annular wall portion 24 has a constant thickness dimension in the fore-and-aft direction X. An angular position about the axis of the front mark 11 provided on the outer peripheral surface of the front ring 4 matches an angular position about the axis of the protruding part 16. That is to say, the front mark 11 is provided at the angular position at which the protruding part 16 is formed.

The rear annular plate portion 25 inclines to the outer peripheral side toward the rear X2. As illustrated in FIG. 4, in detail, the front end of the outer peripheral surface of the rear annular plate portion 25 (portion adjacent to the rear annular wall portion 24) is provided with an annular groove 35, and the portion in which the annular groove 35 is formed is bent to the outer peripheral side so that the rear annular plate portion 25 inclines to the outer peripheral side. That is to say, in the rear annular plate portion 25, the portion in which the annular groove 35 is formed is a bent portion that is bent to the outer peripheral side. The rear portion of the outer peripheral surface of the rear annular plate portion 25 (portion adjacent to the annular protrusion 26) is provided with an annular notch 36. The notch 36 is shallower than the annular groove 35.

The annular protrusion 26 projects in a direction orthogonal to the rear annular plate portion 25. Accordingly, the annular protrusion 26 extends to the front X1 toward the outer peripheral side. In the present embodiment, the annular protrusion 26 has a trapezoidal sectional shape tapering toward the tip. The inner peripheral portion of a projection portion 53 (insertion portion) provided for the rear ring 5 is inserted into the annular recess 27 formed by the rear annular wall portion 24, the rear annular plate portion 25, and the annular protrusion 26.

(Front Inner Ring)

As illustrated in FIG. 3, the front inner ring 3 includes an annular frame 41 for holding the first polarization filter 2 coaxially from the outer peripheral side, and an annular front stopper 42 that projects from the front edge of the annular frame 41 to the inner peripheral side to restrict a movement of the first polarization filter 2 to the front X1. The front stopper 42 is abuttable from the front X1 on the outer peripheral edge of the first polarization filter 2 held to the annular frame 41.

The inner peripheral surface of the annular frame 41 is an annular surface that extends with a constant diameter dimension along the axis L, and is a filter holding surface 43 (holding portion) for holding the first polarization filter 2 coaxially. As illustrated in FIG. 3 and FIG. 4, the annular frame 41 includes a thick frame portion 44 and a thin frame portion 45 in this order from the front X1 toward the rear X2. The outer peripheral surface of the thick frame portion 44 is positioned closer to the outer peripheral side than the outer peripheral surface of the thin frame portion 45 is, and between these portions, an annular rearward surface 44a that extends along the radial direction is formed. On the outer peripheral surface of the thick frame portion 44, an external thread 46 that can be threadedly engaged with the internal thread 30 of the front ring 4 is formed. In the thin frame portion 45, an adhesive injection hole 47 that passes through in the radial direction to be open on the filter holding surface 43 is formed. A plurality of the adhesive injection holes 47 are provided at equal angular intervals about the axis L. The first polarization filter 2 can be fixed to the front inner ring 3 by injecting an adhesive through the adhesive injection hole 47 from the outer peripheral side of the annular frame 41, while holding the first polarization filter 2 to the filter holding surface 43.

The front stopper 42 is an annular protrusion that protrudes from the front edge of the annular frame 41 toward the inner peripheral side. The front stopper 42 includes an annular rear end surface that is a flat surface orthogonal to the axis L. The front stopper 42 has a width dimension from the annular rear end surface to the rear end of the annular frame 41 (width dimension of the filter holding surface 43) larger than a thickness dimension of the first polarization filter 2 held to the filter holding surface 43. The difference between the width dimension of the filter holding surface 43 in the fore-and-aft direction X and the thickness dimension of the first polarization filter 2 is 0.03 mm or less.

The front inner ring 3 is inserted from the front side into the front ring 4 with the first polarization filter 2 held to the inner peripheral side of the annular frame 41. The external thread 46 is then threadedly engaged with the internal thread 30 of the front ring 4 to be screwed until the rear end of the annular frame 41 abuts on the rear annular wall portion 24 of the front ring 4. When the rear end of the annular frame 41 abuts on the rear annular wall portion 24, the annular rearward surface 44a of the front inner ring 3 opposes the front annular wall portion 21 of the front ring 4 in the fore-and-aft direction X with a minute spacing allowed therebetween. In addition, the outer peripheral surface of the thin frame portion 45 of the annular frame 41 also opposes the intermediate annular plate portion 23 in the radial direction with a minute spacing allowed therebetween. Furthermore, the first polarization filter 2 opposes the rear annular wall portion 24 in the fore-and-aft direction X with a minute spacing allowed therebetween. In this manner, the rear annular wall portion 24 functions as a rear stopper that prevents the first polarization filter 2 from moving to the rear X2.

With the rear end of the annular frame 41 of the front inner ring 3 abutting on the rear annular wall portion 24 of the front ring 4, a distance A (width dimension A of the filter holding surface 43) between the front stopper 42 of the front inner ring 3 and the rear annular wall portion 24 is larger than a thickness dimension B of the first polarization filter 2. Accordingly, the first polarization filter 2 is not gripped between the front stopper 42 and the rear annular wall portion 24. Thus, stress (pressure) applied to the first polarization filter 2 from the front ring 4 and the front inner ring 3 is approximately zero.

When the front inner ring 3 is screwed into the front ring 4, and the rear end of the annular frame 41 abuts on the rear annular wall portion 24, the annular rearward surface 44a of the front inner ring 3 may abut on the front annular wall portion 21 of the front ring 4.

In the tip portion of the front ring 4, a part that is positioned closer to the front than the front inner ring 3 is a front mounting portion to which a hood or the like is mounted by utilizing the internal thread 30.

(Rear Ring)

As illustrated in FIG. 3, the rear ring 5 includes an annular portion 50 (rear ring annular portion) extending in the fore-and-aft direction X, a front annular plate portion (rear ring front annular plate portion) extending from the outer peripheral end on the front surface of the annular portion 50 to the front X1 in the axis L direction, and a rear annular plate portion 52 extending from the inner peripheral end on the rear surface of the annular portion 50 to the rear X2 along the axis L. In addition, the rear ring 5 includes an annular projection portion 53 (insertion portion) that projects from about the midpoint of the annular portion 50 in the fore-and-aft direction to the inner peripheral side, and an annular wall portion 54 that projects from the annular portion 50 to the inner peripheral side at a position that is separated from the projection portion 53 to the rear X2. The projection portion 53 may be formed with a plurality of protrusions having circular arc shapes extending in the circumferential direction.

The front annular plate portion 51 has a constant thickness dimension in the radial direction. The front annular plate portion 51 is slidably fitted into the annular step 28 of the front ring 4. In this manner, the outer peripheral surface of the front annular plate portion 51 is steplessly continuous to the outer peripheral surface of the thick portion 22a in the front annular plate portion 22 of the front ring 4.

Among the front surface of the annular portion 50, a front surface portion closer to the inner peripheral side than the front annular plate portion 51 is a surface orthogonal to the axis L, and is a forward annular surface 56 to which the rearward annular surface 33 of the front ring 4 slidably contacts when the front ring 4 rotates with respect to the rear ring 5. As illustrated in FIG. 5, the circular arc groove 17 having the axis L as the center is formed on the outer peripheral side of the forward annular surface 56. In the present embodiment, an angular range θ in which the circular arc groove 17 is formed is 90° about the axis L.

As illustrated in FIG. 3 and FIG. 4, the protruding part 16 provided on the rearward annular surface 33 of the front ring 4 is inserted from the front X1 into the circular arc groove 17. When the rear ring 5 and the front ring 4 are rotated relative to each other about the axis L, the protruding part 16 is movable within the circular arc groove 17 in the circumferential direction, between one end and the other end of the circumferential direction. Accordingly, the front ring 4 held to the rear ring 5 is rotatable in an angular range in which the protruding part 16 moves within the circular arc groove 17. That is to say, the protruding part 16 provided on the rearward annular surface 33 of the front ring 4, and the circular arc groove 17 provided on the forward annular surface 56 of the rear ring 5 into which the protruding part 16 is inserted, constitute the rotation angular range regulating mechanism 58 for regulating an angular range in which the front ring 4 and the rear ring 5 are rotated relative to each other.

In addition, the angular position about the axis of the first rear mark 12 provided on the outer peripheral surface of the rear ring 5 matches the angular position of one end in the circumferential direction of the circular arc groove 17. The angular position about the axis of the second rear mark 13 provided on the outer peripheral surface of the rear ring 5 matches the angular position of the other end in the circumferential direction of the circular arc groove 17.

Accordingly, when the protruding part 16 reaches one end in the circumferential direction of the circular arc groove 17, the front mark 11 and the first rear mark 12 on the outer peripheral surface of the front ring 4 form a line in the fore-and-aft direction X. When the protruding part 16 reaches the other end in the circumferential direction of the circular arc groove 17, the front mark 11 and the second rear mark 13 on the outer peripheral surface of the front ring 4 form a line in the fore-and-aft direction X. In other words, when the camera filter frame 10 is disposed at the first rotation angular position 10A (see FIG. 1) in which the front mark 11 matches the first rear mark 12 in the circumferential direction, the protruding part 16 is positioned at one end in the circumferential direction of the circular arc groove 17. In this manner, since the protruding part 16 is regulated so as not to further move to one side in the circumferential direction, one end of the angular range in which the front ring 4 and the rear ring 5 rotate relative to each other is regulated. In addition, when the camera filter frame 10 is disposed at the second rotation angular position 10B (see FIG. 2) in which the front mark 11 matches the second rear mark 13 in the circumferential direction, the protruding part 16 is positioned at the other end in the circumferential direction of the circular arc groove 17. In this manner, since the protruding part 16 is regulated so as not to further move to the other side in the circumferential direction, the other end of the angular range in which the front ring 4 and the rear ring 5 rotate relative to each other is regulated.

As illustrated in FIG. 4, the projection portion includes a rectangular sectional shape. The inner peripheral end of the projection portion 53 is inserted into the annular recess 27 on the outer peripheral surface of the front inner ring 3. In this manner, the rear ring 5 holds the front ring 4 in a rotatable manner about the axis L. The rear end surface of the rear annular wall portion of the front ring 4 slidably contacts the front end surface of the projection portion 53. A grease holding groove 59 is provided on the outer peripheral side of the front end surface of the projection portion 53. The grease holding groove 59 holds grease to slide the front ring 4 and the rear ring 5 smoothly.

The annular wall portion 54 has a constant thickness in the fore-and-aft direction X. The annular protrusion 26 of the front ring 4 is positioned between the projection portion 53 and the annular wall portion 54 in the fore-and-aft direction X. An internal thread 61 is formed on the inner peripheral surface of the rear annular plate portion 52. An external thread 62 is formed on the outer peripheral surface of the rear annular plate portion 52. A region of the annular wall portion 54 in which the external thread 62 is formed is a rear mounting portion to be utilized when mounting the camera filter unit 1 on a lens-barrel of a camera.

(Rear Inner Ring)

As illustrated in FIG. 4, the rear inner ring 7 includes a rear annular frame 65 for holding the second polarization filter 6 coaxially from the outer peripheral side, and a second rear stopper 66 that projects from the rear edge of the rear annular frame 65 to the inner peripheral side to restrict a movement of the second polarization filter 6 to the rear X2. The second rear stopper 66 is abuttable from the rear X2 on the outer peripheral edge of the second polarization filter 6 held to the rear annular frame 65. The inner peripheral surface of the rear annular frame 65 is an annular surface that extends with a constant diameter dimension along the axis L, and is a rear filter holding surface 68 (second holding portion) for holding the second polarization filter 6 coaxially. The width dimension of the rear filter holding surface 68 in the fore-and-aft direction X is longer than the thickness dimension of the second polarization filter 6. The difference between the width dimension of the rear filter holding surface 68 in the fore-and-aft direction X and the thickness dimension of the second polarization filter 6 is 0.03 mm or less. An external thread 69 that can be threadedly engaged with the internal thread 61 of the rear ring 5 is formed on the outer peripheral surface of the rear inner ring 7.

In the rear annular frame 65, an adhesive injection hole 70 that passes through in the radial direction to be open on the rear filter holding surface 68 is formed. If an adhesive is injected from the outer peripheral side of the rear annular frame 65 through the adhesive injection hole 70 with the second polarization filter 6 held to the rear filter holding surface 68, the adhesive enables the second polarization filter 6 to be fixed to the rear inner ring 7. A plurality of the adhesive injection holes 70 are provided at equal angular intervals.

The rear inner ring 7 is inserted from the rear side into the rear ring 5 with the second polarization filter 6 held to the inner peripheral side of the rear annular frame 65. The external thread 69 is then threadedly engaged with the internal thread 61 of the rear ring 5 to be screwed until the front end of the rear annular frame 65 abuts on the annular wall portion 54 of the rear ring 5.

When the front end of the rear annular frame 65 is screwed until it abuts on the annular wall portion 54, the second polarization filter 6 opposes the annular wall portion 54 in the fore-and-aft direction X with a minute spacing allowed therebetween. In this manner, the annular wall portion 54 functions as a second front stopper that prevents the second polarization filter 6 from moving to the front X1.

When the front end of the rear annular frame 65 abuts on the annular wall portion 54, a distance C between the second rear stopper 66 and the annular wall portion 54 (width dimension C of the filter holding surface 68) is longer than a thickness dimension D of the second polarization filter 6. Accordingly, the second polarization filter 6 is not gripped between the second rear stopper 66 and the annular wall portion 54. Thus, stress (pressure) applied on the second polarization filter from the rear ring 5 and the rear inner ring 7 is approximately zero.

(Assembly of Camera Filter Unit)

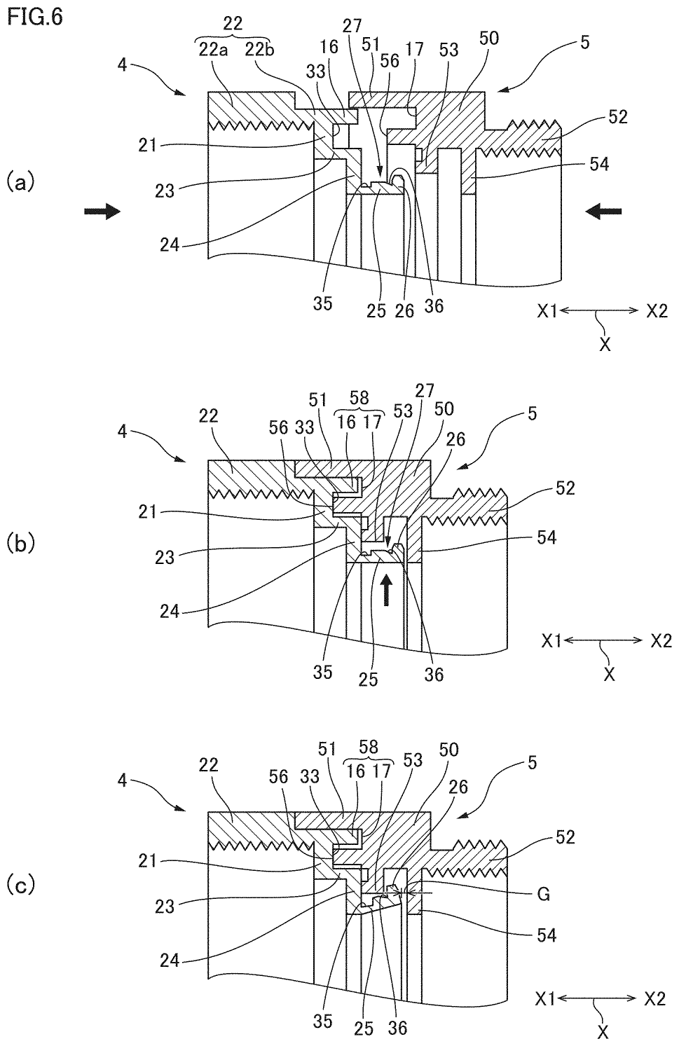

FIG. 6 is a diagram for describing an assembling operation of the camera filter unit 1. In order to assemble the camera filter unit 1, the front ring 4 and the rear ring 5 are first combined with each other in the fore-and-aft direction X as illustrated in FIG. 6A and FIG. 6B so that the position of the projection portion 53 of the rear ring 5 is between the rear annular wall portion 24 of the front ring 4 and the annular protrusion 26 in the fore-and-aft direction X.

In the state before the front ring 4 and the rear ring 5 are combined, the rear annular plate portion 25 of the front ring 4 extends along the axis L, as illustrated in FIG. 6A. Accordingly, the annular protrusion 26 projects from the rear end of the rear annular plate portion 25 in the radial direction, and the annular recess includes a substantially rectangular sectional shape. The notch 36 is notched downward toward the rear X2, and has a triangular sectional shape. In addition, when the front ring 4 and the rear ring 5 are disposed coaxially, the outer peripheral end surface of the annular protrusion 26 of the front ring 4 is positioned flush with an inner peripheral end surface of the projection portion 53 of the rear ring 5, or positioned slightly closer to the inner peripheral side than the inner peripheral end surface is. The front ring 4 is made of metal, and it has elasticity. Accordingly, even if the outer peripheral end surface of the annular protrusion 26 of the front ring 4 is positioned slightly closer to the inner peripheral side than the inner peripheral end surface of the projection portion 53 of the rear ring 5 is, when the front ring 4 and the rear ring 5 are brought close to each other, the projection portion 53 of the rear ring 5 abuts on the annular protrusion 26, and the rear annular plate portion 25 warps to the outer peripheral side. Furthermore, after the annular protrusion 26 of the front ring 4 enters into the space between the rear annular wall portion 24 and the annular protrusion 26, the rear annular plate portion 25 returns to a posture that extends to the rear X2 along the axis L.

Next, as illustrated in FIG. 6B, the forward annular surface 56 of the rear ring 5 is caused to abut on the rearward annular surface 33 of the front ring 4, and the projection portion 53 is caused to abut on the rear annular wall portion 24 of the front ring 4 from the rear X2. At this time, the protruding part 16 of the rearward annular surface 33 is inserted into the circular arc groove 17 of the forward annular surface 56 so as to constitute the rotation angular range regulating mechanism 58.

Subsequently, the rear annular plate portion 25 of the front ring 4 is bent (plastically deformed) to the outer peripheral side to displace the annular protrusion 26 to the outer peripheral side. This structure creates the state in which the projection portion 53 of the rear ring 5 is inserted into the annular recess 27 of the front ring 4.

When the rear annular plate portion 25 of the front ring 4 is bent to the outer peripheral side, force directed from the inner peripheral side to the outer peripheral side in the radial direction is applied to the rear annular plate portion 25. As a result, the rear annular plate portion 25 is bent at the portion on the front end side the thickness of which is reduced by the formation of the annular groove 35, as illustrated in FIG. 6C. In addition, the rear annular plate portion 25 is bent to the outer peripheral side, whereby the annular protrusion 26 projects to the outer peripheral side more than the inner peripheral end surface of the projection portion 53. Accordingly, the state in which the projection portion 53 is inserted into the annular recess 27 is created. The notch 36 serves as a relief part to avoid causing the rear annular plate portion 25 to abut on the projection portion 53 when the rear annular plate portion 25 is bent to the outer peripheral side.

In the present embodiment, the portion the thickness of which is reduced by the formation of the annular groove 35 is provided to the front end of the rear annular plate portion 25 so as to bend the thin portion to the outer peripheral side. Accordingly, the rear annular plate portion 25 can be bent accurately with relatively weak force. This enables the annular protrusion 26 to be displaced accurately to the outer peripheral side, thereby improving the accuracy of dimension between the projection portion 53 of the rear ring 5 and the annular recess 27 of the front ring 4. The annular protrusion 26 of the front ring 4 can therefore be opposed to the projection portion 53 of the rear ring 5 at the rear X2 with a minute spacing G that is set in advance allowed therebetween. In the present embodiment, the spacing G can be between 0.03 mm and 0.1 mm. Accordingly, the front ring 4 can be prevented from rattling with respect to the rear ring 5 when the front ring 4 is rotated. The front ring 4 can also be rotated smoothly with respect to the rear ring 5.

Thereafter, the first polarization filter 2 is inserted into the front inner ring 3 from the rear X2, causing the first polarization filter 2 to abut on the front stopper 42. In addition, an adhesive is injected through the adhesive injection hole 47 to fix the first polarization filter 2 to the front inner ring 3. The front inner ring 3 is then screwed into the front ring 4 from the front X1, causing the rear end of the rear annular frame 65 of the front inner ring 3 to abut on the rear annular wall portion 24 of the front ring 4. In addition, the second polarization filter 6 is inserted into the rear inner ring 7 from the front X1, causing the second polarization filter 6 to abut on the second rear stopper 66. In addition, an adhesive is injected through the adhesive injection hole 70 to fix the second polarization filter 6 to the rear inner ring 7. The rear inner ring 7 is then screwed into the rear ring 5 from the rear X2, causing the rear end of the rear annular frame 65 of the rear inner ring 7 to abut on the annular wall portion 54 of the rear ring 5. This completes the camera filter unit 1.

(Working Effect)

In the present embodiment, the camera filter unit 1 includes the rotation angular range regulating mechanism 58, which includes the protruding part 16 provided on the rearward annular surface 33 of the front ring 4 and the circular arc groove 17 provided on the forward annular surface 56 of the rear ring 5. Accordingly, in the camera filter frame 10, the rotation angular position of the front ring 4 with respect to the rear ring 5 can be regulated between the two positions, which are the first rotation angular position 10A in which the protruding part 16 of the front ring 4 is positioned at one end in the circumferential direction of the circular arc groove 17 of the rear ring 5, and the second rotation angular position 10B in which the protruding part 16 of the front ring 4 is positioned at the other end of the circular arc groove 17 of the rear ring 5. In this manner, the camera filter unit can regulate the relative rotation angular positions about the axis L of the first polarization filter 2 held to the front ring 4 and the second polarization filter 6 held to the rear ring 5. Thus, the desired photographic effects corresponding to the relative rotation angular positions of the two polarization filters 2, 6 can be easily and certainly exerted.

In addition, in the present embodiment, the relative rotation angular positions about the axis L of the first polarization filter 2 and the second polarization filter 6 are correctly regulated at the first rotation angular position 10A and the second rotation angular position 10B. Accordingly, the first light quantity M1 of light passing through the two polarization filters 2, 6 when the camera filter frame 10 is disposed at the first rotation angular position 10A, and the second light quantity M2 of light passing through the two polarization filters 2, 6 when the camera filter frame 10 is disposed at the second rotation angular position 10B can be correctly regulated.

Furthermore, in the present embodiment, the first light quantity M1 of light passing through the two polarization filters 2, 6 when the camera filter frame 10 is disposed at the first rotation angular position 10A is larger than the second light quantity M2 of light passing through the two polarization filters 2, 6 when the camera filter frame 10 is disposed at the second rotation angular position 10B. In addition, the first light quantity M1 is the maximum light quantity that can be obtained by observing light quantity passing through the first polarization filter 2 and the second polarization filter 6 disposed coaxially, while rotating these filters relative to each other. Accordingly, photographing aiming for accurate focusing and desired photographic effects can be quickly performed by focusing the camera at the first rotation angular position 10A that can obtain the bright first light quantity M1, and then clicking the shutter while disposing the camera filter frame 10 at the second rotation angular position 10B.

In addition, in the present embodiment, the front ring 4 includes the rearward annular surface 33 facing the rear X2, and the rear ring 5 includes the forward annular surface 56 slidably contacting the rearward annular surface 33. Further, the protruding part 16 is provided on the rearward annular surface 33, and the circular arc groove 17 for receiving the protruding part 16 is provided on the forward annular surface 56. By causing the forward annular surface 56 provided for the rear ring 5 and the rearward annular surface 33 provided for the front ring 4 to oppose each other in the fore-and-aft direction X and slidably contact each other, the front ring 4 and the rear ring 5 rotate without rattling. In addition, since the rotation angular range regulating mechanism 58 is formed by providing the protruding part 16 for one of the forward annular surface 56 and the rearward annular surface 33 slidably contacting each other, and providing the circular arc groove 17 for the other surface, even when the rotation angular range regulating mechanism 58 is provided, the camera filter frame 10 can be prevented or inhibited from becoming longer in the fore-and-aft direction X. Furthermore, since the protruding part 16 is provided for one of the forward annular surface 56 and the rearward annular surface 33 opposing each other in the fore-and-aft direction X, and the circular arc groove 17 is provided for the other surface, the camera filter frame 10 can be prevented from becoming larger in size in the radial direction as compared to a case in which a pair of annular surfaces opposing each other in the radial direction are provided between the front ring 4 and the rear ring 5, and the protruding part 16 is provided for one of the pair of annular surfaces, while the circular arc groove 17 is provided for the other surface.

In addition, in the present embodiment, the front mark 11 is provided at the angular position about the axis L in which the protruding part 16 is formed on the outer peripheral surface of the front ring 4. Further, on the outer peripheral surface of the rear ring 5, the first rear mark 12 is provided at the angular position about the axis L corresponding to one end in the circumferential direction of the circular arc groove 17, and the second rear mark 13 is provided at the angular position about the axis L corresponding to the other end in the circumferential direction of the circular arc groove 17. Accordingly, when the protruding part 16 reaches one end of the circular arc groove 17, the front mark 11 and the first rear mark 12 form a line in the fore-and-aft direction X. In addition, when the protruding part 16 reaches the other end of the circular arc groove 17, the front mark 11 and the second rear mark 13 form a line in the fore-and-aft direction X. Accordingly, it can be visually confirmed that the rear ring 5 and the front ring 4 are at predetermined relative rotation angular positions (the upper limit position or the lower limit position in the rotation angular range).

Furthermore, in the present embodiment, the rotation angular range regulating mechanism 58 regulates the rotation angular range in which the front ring 4 and the rear ring 5 rotate relative to each other to a rotation angular range smaller than 90°. That is to say, since the circular arc groove 17 is formed to have the angular range of 90° about the axis L, the movable angular range of the protruding part 16 moving in the interior thereof will be 90° or smaller, and the rotation angular range in which the front ring 4 and the rear ring 5 rotate relative to each other will be a rotation angular range smaller than 90°. By setting the rotation angular range in which the front ring 4 and the rear ring 5 rotate relative to each other to the rotation angular range smaller than 90°, when a polarization filter or cross filter is held to the front ring 4 and the rear ring 5, the relative angular positions of the front ring 4 and the rear ring 5 are easily maintained while exerting the desired photographic effects.

In addition, in the present embodiment, the front ring 4 includes the rear annular wall portion 24 extending in the radial direction, the rear annular plate portion 25 extending from the inner peripheral end of the annular wall portion 54 to the outer peripheral side toward the rear X2, the annular protrusion 26 projecting for a shorter distance than the rear annular wall portion 24 from the rear end of the rear annular plate portion 25 toward the outer peripheral side, and the annular recess 27 partitioned by the rear annular wall portion 24, the rear annular plate portion 25, and the annular protrusion 26. Further, the rear ring 5 includes the projection portion 53, which is inserted into the annular recess 27 from the outer peripheral side. With such configuration, the rear ring 5 can easily hold the front ring 4 in a rotatable manner. In addition, with such configuration, the rear ring 5 can hold the front ring 4 in a rotatable manner without interposing another member between the front ring 4 and the rear ring 5.

(Modification)

Although the angular range θ in which the circular arc groove 17 is formed is 90° about the axis L in the above-described embodiment, the angular range θ is not limited to 90°. That is to say, the angular range θ may be smaller or larger than 90°.

In addition, the rotation angular range regulating mechanism 58 may be formed by providing an annular groove on the rearward annular surface 33 of the front ring 4, and the protruding part 16 on the forward annular surface 56 of the rear ring 5.

Furthermore, the adhesive injection hole 47 of the front inner ring 3 and the adhesive injection hole 70 of the rear inner ring 7 may be omitted. That is to say, the first polarization filter 2 may not be fixed to the front inner ring 3 using an adhesive. Even in such case, the difference between the distance A between the front stopper 42 of the front inner ring 3 and the rear annular wall portion 24 (rear stopper), and the thickness dimension B of the first polarization filter 2 is very slight, and thus the first polarization filter 2 does not rattle. In addition, the second polarization filter 6 may not be fixed to the rear inner ring 7 using an adhesive. Even in such case, the difference between the distance C between the second rear stopper 66 and the annular wall portion 54 (second front stopper), and the thickness dimension D of the second polarization filter 6 is very slight, and thus the second polarization filter 6 does not rattle.

In addition, although the annular groove 35 is cut on the outer peripheral surface of the rear annular plate portion 25 of the front ring 4 in the above-described embodiment, an annular groove may be cut at the front end on the inner peripheral surface of the rear annular plate portion 25, and the rear annular plate portion 25 may be bent from the position in which the annular groove is formed to the outer peripheral side. Alternatively, annular grooves may be cut in both of the front end on the inner peripheral surface and the front end on the outer peripheral surface of the rear annular plate portion 25, and the rear annular plate portion 25 may be bent to the outer peripheral side from the position in which these annular grooves are formed. Moreover, the annular groove 35 and the notch 36 may be omitted.

Although the front ring 4 holds the first polarization filter 2 by providing the filter holding surface 43 (holding portion) for the front inner ring 3 held to the inner peripheral side in the above-described embodiment, the front inner ring 3 may be omitted, and an annular filter holding surface (holding portion) may be provided on the inner peripheral side of the front ring 4, thereby allowing the front ring 4 to directly hold the first polarization filter 2. In this case, a retaining ring that is fixed on the inner peripheral surface of the front ring 4 can be used as the front stopper. Although the rear ring 5 holds the second polarization filter 6 by providing the rear filter holding surface 68 (second holding portion) for the rear inner ring 7 held to the inner peripheral side in the above-described embodiment, the rear inner ring 7 may be omitted, and an annular filter holding surface (second holding portion) may be provided on the inner peripheral side of the rear ring 5, thereby allowing the rear ring 5 to directly hold the second polarization filter 6. In this case, a retaining ring that is fixed on the inner peripheral surface of the rear ring 5 can be used as the second rear stopper.

In the above-described embodiment, light quantity of light passing through the first polarization filter 2 and the second polarization filter 6 becomes the maximum first light quantity M1 when the camera filter frame 10 is at the first rotation angular position 10A. In contrast, the relative angles of the first polarization filter 2 and the second polarization filter 6 may be set such that light quantity of light passing through the first polarization filter 2 and the second polarization filter 6 does not become the maximum when the camera filter frame 10 is at the first rotation angular position 10A.

Although the angular range θ in which the circular arc groove 17 is formed is 90° in the above-described embodiment, an angular range smaller than 90° may be set. In addition, the circular arc groove 17 may have an angular range larger than 90°.

Furthermore, the first rotation angular position 10A and the second rotation angular position 10B may be set such that the first light quantity M1 when the camera filter frame 10 is at the first rotation angular position 10A is smaller than the second light quantity M2 when the camera filter frame 10 is at the second rotation angular position 10B.

Polarization filters that are not circular polarization filters may be used as the first polarization filter 2 and the second polarization filter 6.

A cross filter may be held to the front ring 4 and the rear ring 5 as an optical element. Furthermore, a color filter may be held to one of the front ring 4 and the rear ring 5, and a polarization filter or cross filter may be held to the other ring.

Although the second polarization filter 6 is held to the rear ring 5 in the above-described embodiment, an optical element may not be held to the rear ring 5. That is to say, the camera filter unit 1 may include a sheet of optical element held to the front ring 4. In this case, the annular wall portion 54 and the rear inner ring 7 of the rear ring 5 can be omitted.

1. A camera filter frame, comprising:
a front ring having a holding portion for holding an optical element on the inner peripheral side;
a rear ring disposed coaxially with the front ring to hold the front ring in a rotatable manner from a rear side; and
a rotation angular range regulating mechanism for regulating an angular range in which the front ring and the rear ring rotate relative to each other, wherein
the rotation angular range regulating mechanism includes a protruding part that is provided for one of the front ring and the rear ring, and a circular arc groove into which the protruding part is inserted that is provided for the other ring.

2. The camera filter frame according to claim 1, wherein
the front ring includes a rearward annular surface facing the rear side,
the rear ring includes a forward annular surface facing the front side and slidably contacting the rearward annular surface,
the protruding part is provided for one of the rearward annular surface and the forward annular surface, and the circular arc groove is provided for the other surface.

3. The camera filter frame according to claim 1, wherein
a first mark is provided at an angular position about the axis in which the protruding part is formed on an outer peripheral surface of one ring out of the front ring and the rear ring for which the protruding part is provided, and
a second mark is provided at an angular position about the axis corresponding to one end in a circumferential direction of the circular arc groove on an outer peripheral surface of the other ring.

4. The camera filter frame according to claim 1, wherein the rotation angular range regulating mechanism regulates a rotation angular range in which the front ring and the rear ring rotate relative to each other to a rotation angular range smaller than 90°.

5. The camera filter frame according to claim 1, wherein
the front ring comprises:
an annular wall portion extending in a radial direction;
an annular plate portion extending from an inner peripheral end of the annular wall portion to an outer peripheral side toward the rear side;
an annular projection portion projecting for a shorter distance than the annular wall portion from a rear end of the annular plate portion toward the outer peripheral side; and
an annular recess that is partitioned by the annular wall portion, the annular plate portion, and the annular projection portion, wherein
the rear ring includes an insertion portion that is inserted into the annular recess from the outer peripheral side.

6. The camera filter frame according to claim 5, wherein
the front ring includes a front annular wall portion extending in the radial direction in a front side and the outer peripheral side of the annular plate portion, and an intermediate annular plate portion extending from the inner peripheral end of the front annular wall portion to the rear side along the axis,
the front annular wall portion includes the rearward annular surface,
the annular plate portion extends in the radial direction from the rear end of the intermediate annular plate portion toward the inner peripheral side,
the rear ring includes a rear ring annular portion extending along the axis, and a rear ring front annular plate portion extending from an outer peripheral end on a front surface of the rear ring annular portion to the front side,
a front surface portion closer to the inner peripheral side than the rear ring front annular plate portion among the front surface of the rear ring annular portion is the forward annular surface, and
the insertion portion projects from the rear ring annular portion to the inner peripheral side.

7. The camera filter frame according to claim 1, wherein the rear ring has a second holding portion for holding a second optical element on the inner peripheral side.

8. A camera filter unit, comprising:
the camera filter frame according to claim 1; and
the optical element held to the holding portion of the front ring.

9. A camera filter unit, comprising:
the camera filter frame according to claim 7;
the optical element held to the holding portion of the front ring; and
the second optical element held to the second holding portion of the rear ring.

10. A camera filter unit, comprising:
the camera filter frame according to claim 7;
the optical element held to the holding portion of the front ring; and
the second optical element held to the second holding portion of the rear ring, wherein
the optical element and the second optical element are both polarization filters, and
first light quantity of light passing through the optical element and the second optical element when the protruding part is positioned at one end in the circumferential direction of the circular arc groove is larger than second light quantity of light passing through the optical element and the second optical element when the protruding part is positioned at the other end in the circumferential direction of the circular arc groove.
